(19) United States
(12) Patent Application Publication
(10) Pub. No.: US 2009/0019259 A1
(43) Pub. Date: Jan. 15, 2009

(54) MULTIPROCESSING METHOD AND MULTIPROCESSOR SYSTEM

(75) Inventors: Takahisa SUZUKI, Kawasaki (JP); Makiko Ito, Kawasaki (JP); Hideo Miyake, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/235,209

(22) Filed: Sep. 22, 2008

Related U.S. Application Data
(63) Continuation of application No. PCT/JP2006/305867, filed on Mar. 29, 2006.

(51) Int. Cl. G06F 15/76; G06F 9/02

(52) U.S. Cl. 712/29; 712/E09.002

(57) ABSTRACT

A multiprocessing method and a multiprocessor system capable of reducing time lost due to sequential waiting when procedures (program units) having dependencies are executed in which an order of execution of a plurality of program units in a sequential execution program and dependencies of the plurality of program units are registered, the execution states of the plurality of program units are managed based on the registered dependencies, executable program units are determined, and are assigned to server processors sequentially and executed are disclosed.

### CROSS-REFERENCE TO RELATED APPLICATION

This application is a Continuation Application based on International Application Number PCT/JP2006/305867, filed on Mar. 23, 2006.

### BACKGROUND OF THE INVENTION

1. Technical Field

The disclosed embodiments relate to a multiprocessing method and a multiprocessor system, and more specifically, to a multiprocessing method and a multiprocessor system, in which a client processor executes a plurality of program units stored in a sequential execution program in order by assigning them to a server processor.

2. Related Art

A multiprocessor system is known that connects a plurality of processors to each another via a communication path and carries out processes in a sharing manner. Multiprocessor systems include a system in which each processor plays the same role and a client-server system in which one of the processors is a client processor (machine) and other processors are server processors (machines) and the client processor assigns processes to each server processor and carries out processes to put together respective outputs. The disclosed embodiments relate to a client-server based multiprocessor system.

As a communication system between processors in a multiprocessor system, various systems have been proposed and a typical one is a shared memory system. FIG. 1 is a diagram showing a general configuration of a shared memory based multiprocessor system. As shown in FIG. 1, the system has a shared bus 2, a plurality of processors 1-0, 1-1, 1-2, . . . , 1-N connected to shared bus 2, and a shared memory 3. When transmitting data, each processor writes data to transmit to shared memory 3 and notifies a processor of transmission destination of information such as the position of written data etc. The processor notified of the information accesses shared memory 3 to obtain the written data. The disclosed embodiments are not limited to the system having a shared memory, as shown in FIG. 1, but can be applied to any multiprocessor system provided communication can be established between processors in the system.

Although there are also various forms of programs executed by a multiprocessor system, the disclosed embodiments take a multiprocessor system as its subject that executes a sequential execution program including program units to be executed in order.

In a client-server based multiprocessor system, a client processor requests a server processor to carry out processing in the form of a procedure call. This method is referred to as a remote procedure call.

With the remote procedure call, after requesting the server processor to carry out the process, the client processor has to wait until the server processor completes the process and notifies the client processor of that, however, as a method in which the client server can continue an another process without the need to wait until the server processor completes the process, there is an asynchronous remote procedure call.

In a multiprocessor system, an asynchronous remote procedure call is utilized and parallel processing is carried out by a client processor carrying out the asynchronous remote procedure call for a plurality of server processors. FIG. 2 is a diagram explaining parallel processing using an asynchronous remote procedure call. A client processor instructs a server processor on the side that executes a procedure (program unit) to activate a specified procedure with “start” and waits for the completion of the specified procedure with “wait”. In FIG. 2, the client processor assigns a procedure (program unit) A to server processor 1-1, a procedure (program unit) B to server processor 1-2, and a procedure (program unit) C to server processor 1-3 by utilizing the asynchronous remote procedure call and causes them to execute the procedures, and in the meantime, client processor 1-0 on the procedure request side executes a procedure (program unit) D. Due to this, four kinds of processes can be carried out in a parallel manner.

When parallel processing is carried out by utilizing an asynchronous remote procedure call, there arises a problem of time lost of sequential waiting. FIG. 3 is a diagram explaining this problem. In FIG. 3, server processor 1-1 executes procedures A and C and server processor 1-2 executes procedures B and D. At this time, client processor 1-0 on the procedure call side, assuming that procedure A is completed earlier, and after activating procedures A and B, activates procedure C to start upon the completion of procedure A and then activates procedure D to start upon completion of procedure B. However, in practical execution, if procedure B be completed earlier, procedure D will not be activated until procedure A is completed even though procedure B has been completed, and therefore, server processor 1-2 wastes time waiting.

In order to solve the above-mentioned problem, a solution by queuing as shown in FIG. 4 is considered. According to a configuration shown in FIG. 4, client processor 1-0 on the procedure request side reads program units A, B, C, and D to be executed from the sequential execution program into a sequential execution list 5 sequentially. Client processor 1-0 has a procedure request program 6 that carries out processing to assign a procedure (program unit) read into execution list 5 to a server processor. Server processors 1-1, 1-2 on the procedure execution side have procedure call programs 7-1, 7-2 to carry out call processing to execute a procedure (program unit). Because server processors 1-1, 1-2 on the procedure execution side have execution queues 8-1, 8-2 in procedure call programs 7-1, 7-2 to execute a procedure specified by client processor 1-0 on the procedure request side, it is made possible for client processor 1-0 on the procedure request side to request the next procedure call without the need to wait for the completion of the preceding procedure by queuing requests of procedure call programs. Due to this, the problem of time lost of sequential waiting is solved and time lost can be reduced.

However, when program units having dependencies between procedures are assigned to different processors, the above-mentioned simple queuing causes waiting for the completion of procedure and there arises a time lost owing to the problem of time lost of sequential waiting.

An object of the disclosed embodiments are to realize a multiprocessing method and a multiprocessor system capable of reducing a time lost owing to sequential waiting when procedures (program units) having the above-mentioned dependencies are executed.

### SUMMARY

According to an aspect of the disclosed embodiments, an order of execution of a plurality of program units in a sequential execution program and dependencies of the plurality of program units are registered, the execution states of the plurality of program units are managed based on the registered dependencies, executable program units are determined, and the executable program units are sequentially assigned to server processors to be executed.

### BRIEF DESCRIPTION OF DRAWINGS

FIG. 1 is a diagram showing a general configuration of an example of a multiprocessor system which the disclosed embodiments take as a subject.

FIG. 2 is a diagram showing parallel processing using an asynchronous call.

FIG. 3 is a diagram explaining a problem of time lost of sequential waiting in the parallel processing.

FIG. 4 is a diagram showing a solution by queuing of the problem of time lost of sequential waiting in FIG. 3.

FIG. 5 is a diagram showing a procedure (program unit) having dependencies.

FIG. 6 is a diagram explaining a problem of a conventional method.

FIG. 7 is a diagram showing parallel processing in a first embodiment.

FIG. 8 is a flowchart showing procedure request processing after a procedure activation request (dispatch) in the parallel processing in the first embodiment.

FIG. 9 is a flow chart showing the procedure call processing in the first embodiment.

FIG. 10 is a flowchart showing termination notification processing on the procedure request side in the first embodiment.

FIG. 11 is a diagram showing parallel processing in a second embodiment.

FIG. 12 is a flowchart showing procedure request processing after a procedure activation request (dispatch) in the parallel processing in the second embodiment.

FIG. 13 is a diagram showing parallel processing in a third embodiment.

FIG. 14 is a flowchart showing procedure request processing after a procedure activation request (dispatch) in the parallel. processing in the third embodiment.

FIG. 15 is a diagram showing parallel processing in a fourth embodiment.

FIG. 16 is a flowchart showing procedure request processing after a procedure activation request (dispatch) in the parallel processing in the fourth embodiment.

FIG. 17 is a flowchart showing procedure call processing in the parallel processing in the fourth embodiment.

FIG. 18 is a flowchart showing termination notification processing in the parallel processing in the fourth embodiment.

FIG. 19 is a diagram showing parallel processing in a fifth embodiment.

FIG. 20 is a flowchart showing procedure request processing after a procedure activation request (dispatch) in parallel processing in a sixth embodiment.

FIG. 21 is a flowchart showing procedure call processing in the parallel processing in the sixth embodiment.

FIG. 22 is a diagram showing parallel processing in a seventh embodiment.

FIG. 23 is a flowchart showing procedure request processing after a procedure activation request (dispatch) in the parallel processing in the seventh embodiment.

FIG. 24 is a diagram showing parallel processing in an eighth embodiment.

### DESCRIPTION OF THE PREFERRED EMBODIMENTS

Before describing preferred embodiments, problems of the related art are described.

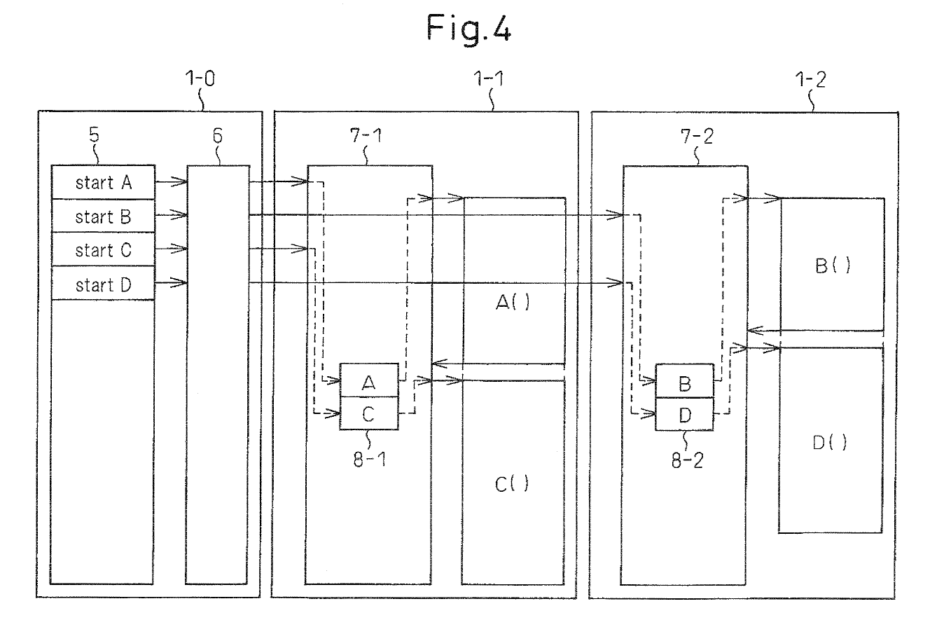

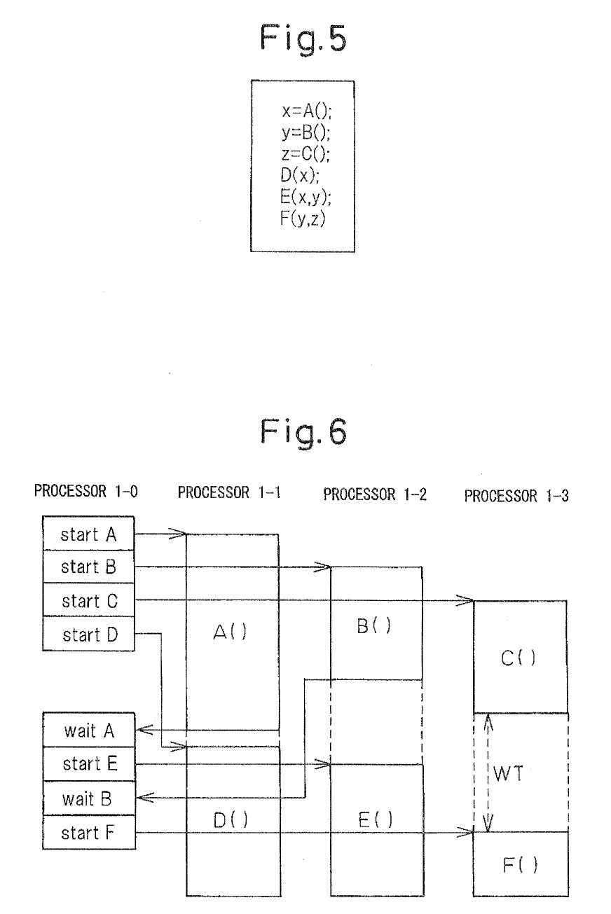

As shown in FIG. 4, queuing of a request of procedure call is carried out. However, only by simply queuing as shown in FIG. 4, when program units having dependencies between procedures are assigned to different processors as shown in FIG. 5, it is necessary to wait for the completion of procedures and there arises a time lost owing to sequential waiting. FIG. 6 is a diagram explaining this problem, showing the case where the program units shown in FIG. 5 are executed.

In FIG. 6, the program units shown in FIG. 5 are brought into parallelism with each another by utilizing the asynchronous procedure call. There is no dependency among procedures A, B, and C, and therefore, it is possible to execute the procedures in a parallel manner with three server processors 1-1 to 1-3. Because procedure D has a dependency only with procedure A, it is only required to queue server processor 1-1. Because procedure E has dependencies with procedures A and B, it is necessary to queue server processor 1-2 after procedure B is completed and further procedure A is completed. Similarly, a procedure F queues server processor 1-3 after it waits until procedure B is completed. The order of waiting for the completion of procedures A and B causes a problem. In FIG. 6, on the assumption that procedure A is completed earlier than procedure B, the completion of procedure A is awaited. In other words, the completion of procedure B is not watched. However, in actuality, procedure B will be completed first, and therefore, there occurs a time lost for execution of procedure F.

The preferred embodiments are explained below. In the following embodiments, it is assumed that a multiprocessor system comprising one client processor and three server processors in FIG. 6 executes a sequential execution program having program units in FIG. 5.

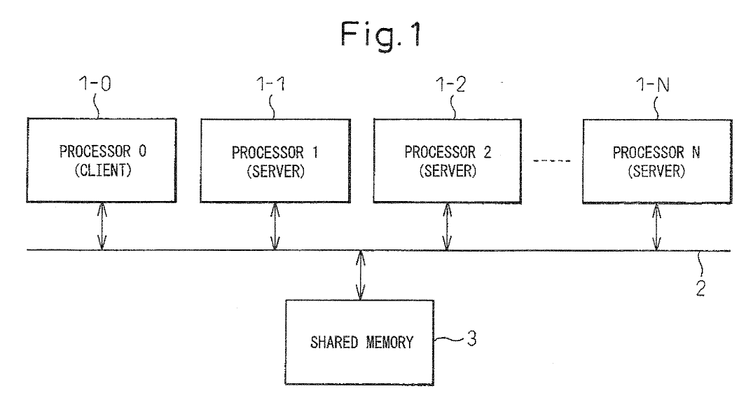

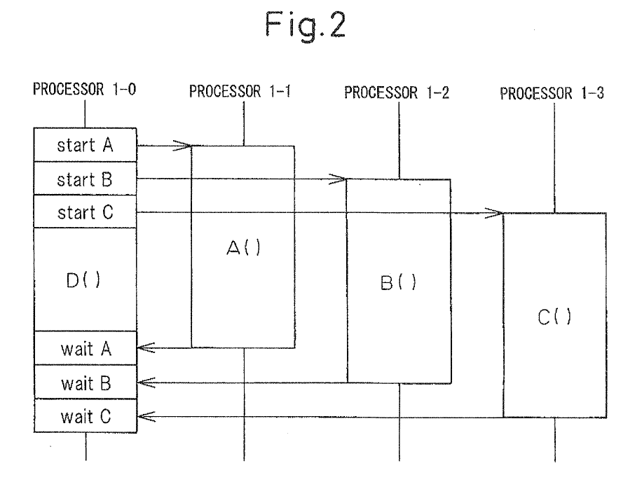

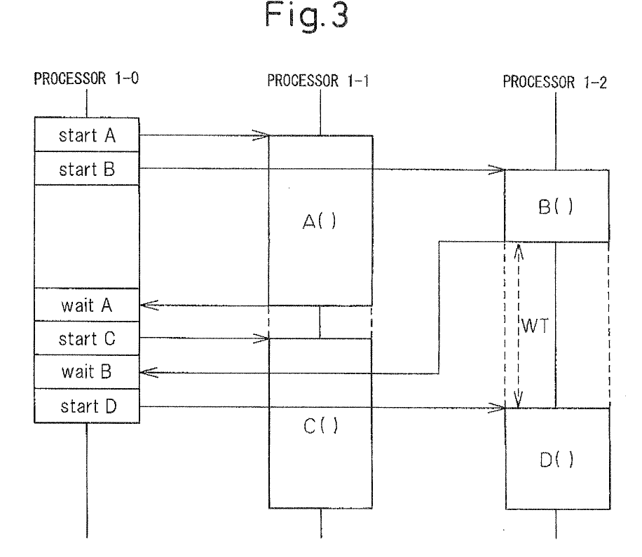

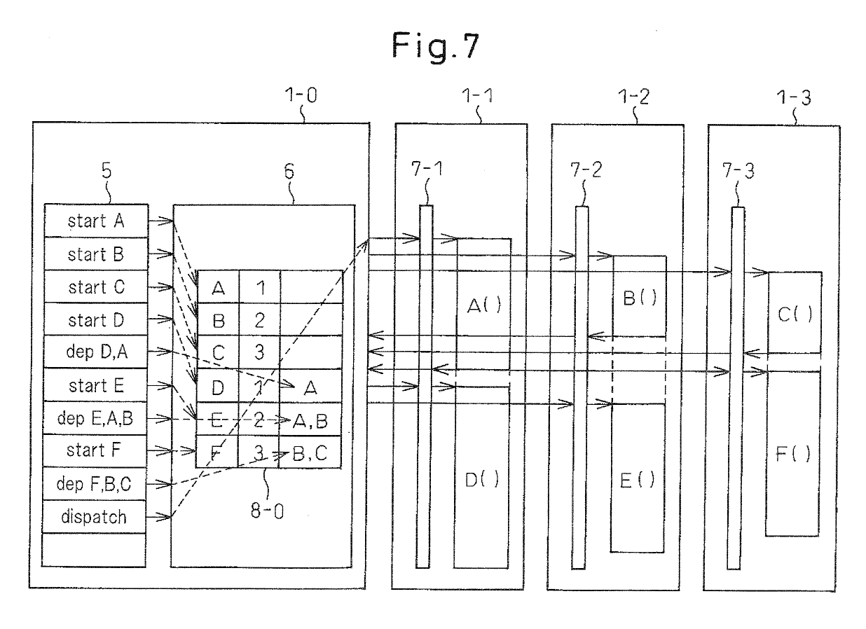

FIG. 7 is a diagram explaining parallel processing in a multiprocessor system in a first embodiment. The multiprocessor system in the first embodiment is, for example, a system having a shared memory as shown in FIG. 1, however, can be any system provided it is a client-server based multiprocessor system that executes a sequential execution program.

As shown in FIG. 7, the multiprocessor system in the first embodiment comprises client processor 1-0 and three server processors 1-1, 1-2, and 1-3; however the number of server processors can be two at least. Client processor 1-0 on the procedure request side reads program units (procedures) A, B, C, D, E, and F to be executed from the sequential execution program into execution list 5. In the sequential execution program, dependencies of the procedures are also described and these are also read into execution list 5.

Client processor 1-0 on the procedure request side has procedure request program 6 that carries out processing to assign a procedure to the server processor. Server processors 1-1, 1-2, and 1-3 on the procedure execution side have procedure call programs 7-1, 7-2, and 7-3 that carry out processing to call a procedure (program unit) specified by client processor 1-0 for execution.

In execution list 5, the procedures to be executed are read in order and “start” is added and when there are dependencies, the dependencies are described with “dep” afterward. In the example shown schematically, there is no dependency among procedures A, B, and C, however, procedure D has a dependency in that it uses the processing results of procedure A, procedure E has dependencies in that it uses the processing results of procedures A and B, and procedure F has dependencies in that it uses the processing results of procedures B and C. When the creation of execution list 5 is completed, the start of execution is instructed with “dispatch”. Conventionally, when the description of a procedure is carried out with “start”, the immediate start of execution is instructed. However, the description of a procedure does not describes a dependency. In the present embodiment, the start of execution is instructed with “dispatch” after procedures with “start” and “dep” are completed.

Procedure request program 6 of client processor 1-0 has one execution queue 8-0. When a procedure (program unit) to be executed and its dependencies are described in execution list 5, procedure request program 6 registers the information in execution queue 8-0 and at the same time, determines a server processor that executes each procedure and registers the information in execution queue 8-0. In the example shown schematically, in addition to the procedure to be execute and its dependencies, information about that procedures A and D are executed by server processor 1-1, procedures B and E by server processor 1-2, and procedures C and F by server processor 1-3 is registered.

When “dispatch” is input in execution list 5, procedure request program 6 carries out processing to assign procedures registered in execution queue 8-0 to each of server processors 1-1, 1-2, and 1-3.

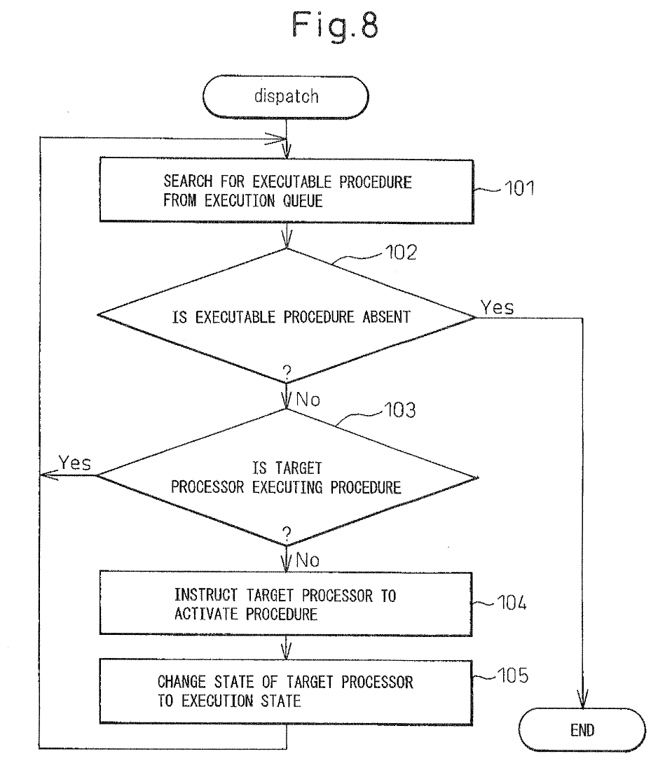

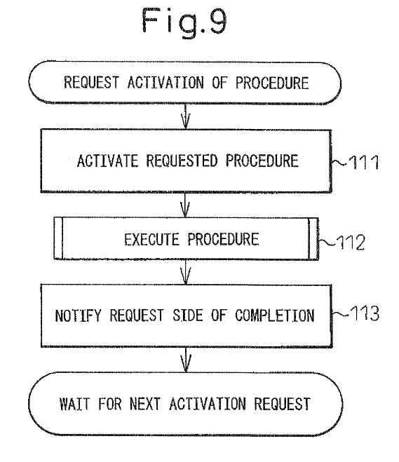

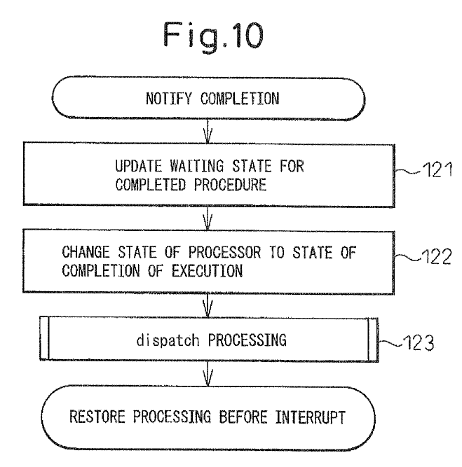

FIG. 8 is a flowchart showing processing of procedure request program 6 after “dispatch” is issued (hereinafter, referred to as processing after dispatch). FIG. 9 is a flowchart showing the processing of procedure call programs 7-1, 7-2, and 7-3 of server processors 1-1, 1-2, and 1-3 after the procedure activation request is issued from procedure request program 6, and FIG. 10 is a flowchart showing the processing of procedure request program 6 after the completion of procedure is notified from procedure call programs 7-1, 7-2, and 7-3.

Procedure request program 6 searches for an executable procedure from execution queue 8-0 in step 101. In step 102, procedure request program 6 determines whether there is an executable procedure and if not, it ends the processing. After ending the processing, it is possible for procedure request program 6 to carry out another processing not described here. When there is an executable procedure, procedure request program 6 determines whether a target server processor is executing a procedure, which is specified to execute an executable procedure in execution queue 8-0 in step 103. When it is executing a procedure, procedure request program 6 returns the processing to step 101, and if not, it advances the processing to step 104 and instructs the target sever processor to activate the procedure. Then, in step 105, procedure request program 6 changes the state of the target server processor to the execution state and returns the processing to step 101.

In the case of first procedure A, target server processor 1-1 is not in execution, and therefore procedure request program 6 instructs server processor 1-1 to activate procedure A. Subsequently, procedure request program 6 instructs server processor 1-2 to activate procedure B and server processor 1-3 to activate procedure C.

After procedure request program 6 has been instructed to activate procedure C, the three processors are all in the state of executing procedures, and therefore, the result of the determination in step 103 is “Yes” and after the processing is returned to step 101, it is determined that there is no executable procedure in step 103, and therefore, procedure request program 6 ends the processing. Because client processor 1-0 receives the notification of termination by interrupt, as will be described later, and until that time, it continues to carry out another processing.

On the other hand, in server processors 1-1, 1-2, and 1-3 having received the procedure activation request, their procedure call programs 7-1, 7-2, and 7-3 carry out the processing in FIG. 9, respectively. Upon receipt of the procedure activation request, the procedure call program activates the requested procedure in step 111 and executes the procedure in step 112. Then, the procedure call program waits for the completion of the procedure and when the procedure is completed, the procedure call program notifies procedure request program 6 of client processor 1-0 on the procedure request side of the completion of the procedure in step 113. Then, the procedure call program waits for the arrival of the next activation request.

Upon receipt of the notification of completion of the procedure from the procedure call program by interrupt processing, procedure request program 6 updates execution queue 8-0 so that the completed procedure is changed from the execution state to the state of completion in step 121 as shown in FIG. 10. Then, in step 122, procedure request program 6 changes the state of the server processor that has executed the procedure to the state of completion, that is, the vacant state. In step 123, procedure request program 6 also carries out the “dispatch” processing in FIG. 8. When the “dispatch” processing in FIG. 8 ends, procedure request program 6 returns to the state before the interrupt.

Returning to FIG. 7 and FIG. 8 again, after instructing the activation request of procedures A, B, and C, procedure request program 6 is in a loop between steps 101 and 103. Among the three procedures, the processing of procedure B by server processor 1-2 is first completed, then procedure request program 6 receives the notification of completion and carries out the processing in FIG. 10. Procedure D that remains depends on procedure A, procedure E depends on procedures A, B, and procedure F depends on procedures B, C, and therefore, in step 102 in FIG. 8, it is determined that there is no executable procedure. Next, the processing of procedure C by server processor 1-3 is completed and procedure request program 6 receives the notification of completion similarly, procedure request program 6 carries out the processing in FIG. 10 and requests server processor 1-3 to activate procedure F when procedure F become executable and server processor 1-3 enters the vacant state. Further, when the processing of procedure A by server processor 1-1 is completed and the notification of completion is received, procedures D and E become executable similarly and server processor 1-1 enters the vacant state, and server processor 1-2 is already in the vacant state, and therefore, procedure request program 6 requests server processor 1-1 to activate procedure D and requests server processor 1-2 to activate procedure E.

After requesting the servers to activate procedures D and E, there is no procedure left to be executed and it is determined that there is no executable procedure in step 102 in FIG. 8, and therefore, procedure request program 6 ends the processing. Afterward, when the processing of procedures D, E, and F is completed, procedure request program 6 carries out the same processing as that in FIG. 10 and ends the processing because there is no procedure left to be executed.

As obvious from the comparison between FIG. 6 and FIG. 7, in the conventional case, after procedure C is completed, there is a waiting time WT before procedure F is activated in server processor 1-3, however, in the first embodiment, after procedure C is completed, procedure F is activated immediately.

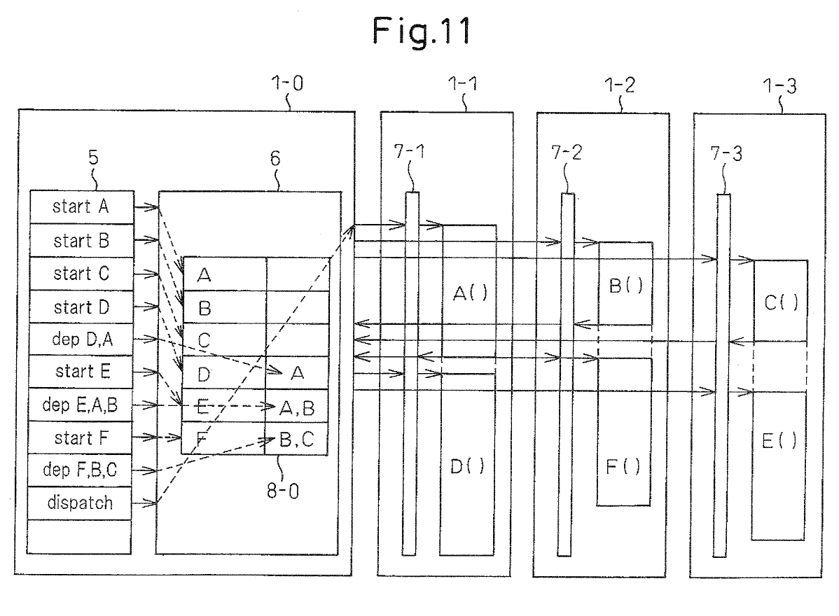

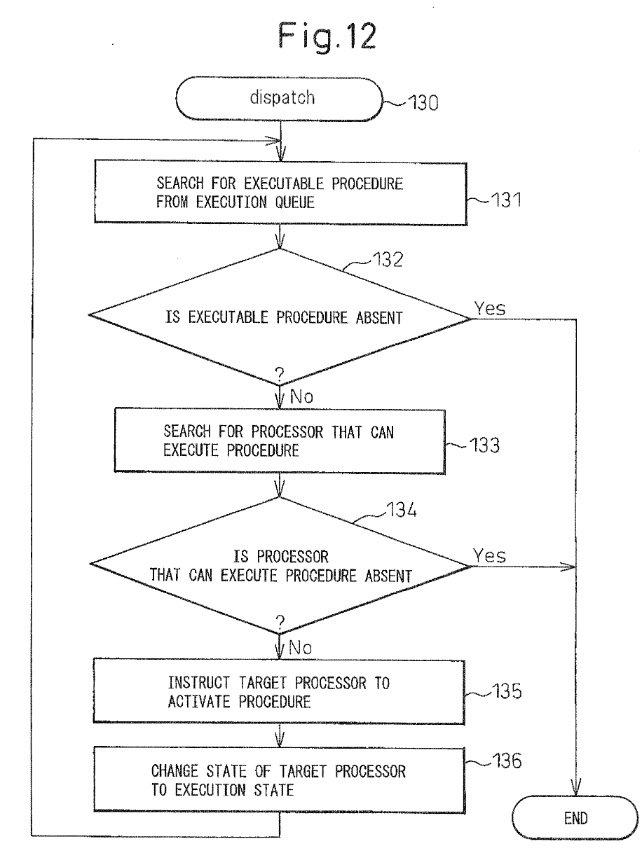

FIG. 11 is a diagram explaining parallel processing in a multiprocessor system in a second embodiment. The multiprocessor system in the second embodiment differs from that in the first embodiment in that a serve processor that executes each procedure is not specified in execution queue 8-0 of procedure request program 6 but a server processor that executes each procedure is dynamically determined in accordance with the processing circumstances, and others are the same as those in the first embodiment. In order to dynamically determine a server processor that executes each procedure, procedure request program 6 carries out processing after dispatch in FIG. 12 instead of the processing in FIG. 8.

In the processing after dispatch in the second embodiment in FIG. 12, steps 131 and 132, which are the same as steps 101 and 102 in the first embodiment, are carried out. In step 132, if it is determined that there is an executable procedure, procedure request program 6 searches for a server processor that can execute a procedure in step 133 and determines whether there is a server processor that can execute a procedure in step 134, and if not, procedure request program 6 ends the processing and if there is a server processor, the processing proceeds to step 135. Steps 135 and 136 are the same as steps 104 and 105 in the first embodiment.

As shown in FIG. 11, in the second embodiment, when procedures B and C are completed, procedure F can be executed and server processors 1-2 and 1-3 are in the vacant state, and therefore, procedure request program 6 instructs server processor 1-2 to activate procedure F.

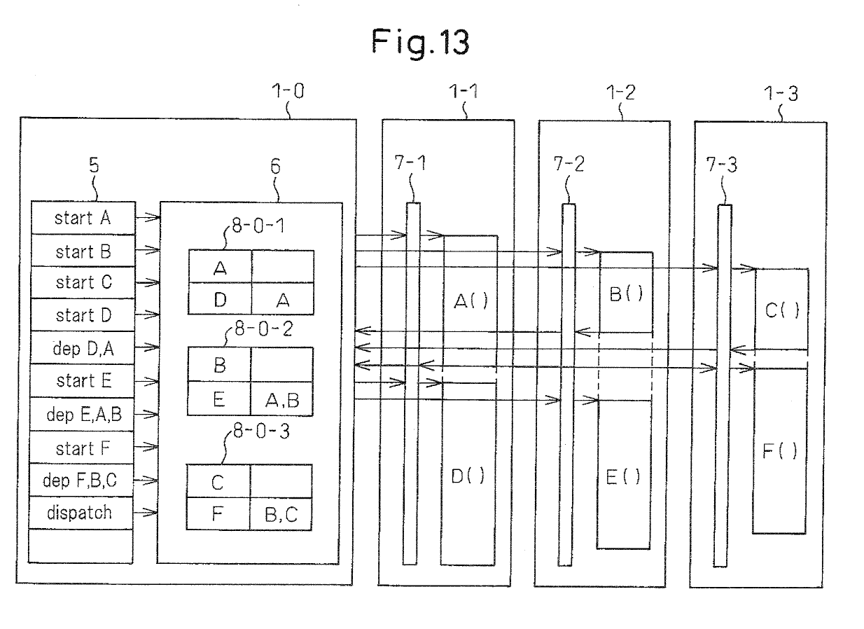

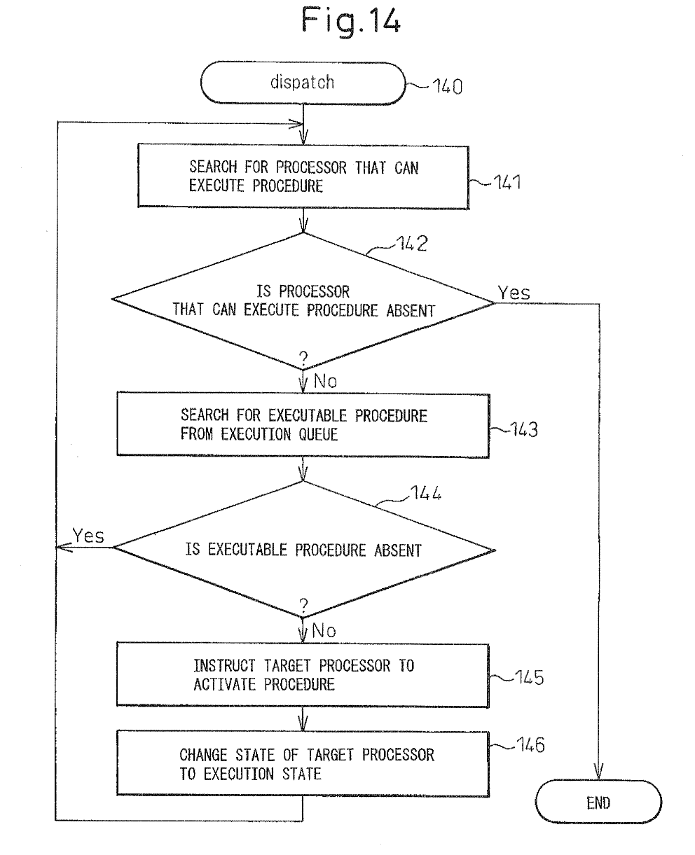

FIG. 13 is a diagram explaining parallel processing in a multiprocessor system in a third embodiment. The multiprocessor system in the third embodiment differs from that in the first embodiment in that procedure request program 6 has three execution queues 8-0-1, 8-0-2, and 8-0-3 in correspondence to three server processors, and others are the same as those in the first embodiment. Procedure request program 6 carries out processing after dispatch in FIG. 14 instead of the processing in FIG. 8.

According to the processing after dispatch in the third embodiment in FIG. 14, upon receipt of “dispatch”, procedure request program 6 searches for a server processor that can execute a procedure, that is, a server processor in the vacant state in step 141. In step 142, procedure request program 6 determines whether there is a server processor that can execute a procedure. If there is no server processor that can execute a procedure, it is not possible to activate a new procedure, and therefore, procedure request program 6 ends the processing. If there is a server processor that can execute a procedure, procedure request program 6 searches for an executable procedure from an execution queue corresponding to the server processor from among execution queues 8-0-1, 8-0-2, and 8-0-3 in step 143. In step 144, procedure request program 6 determines whether there is an executable procedure and if not, the processing returns to step 141 and if there is an executable procedure, the processing proceeds to step 145. Steps 145 and 146 are the same as steps 104 and 105 in the first embodiment.

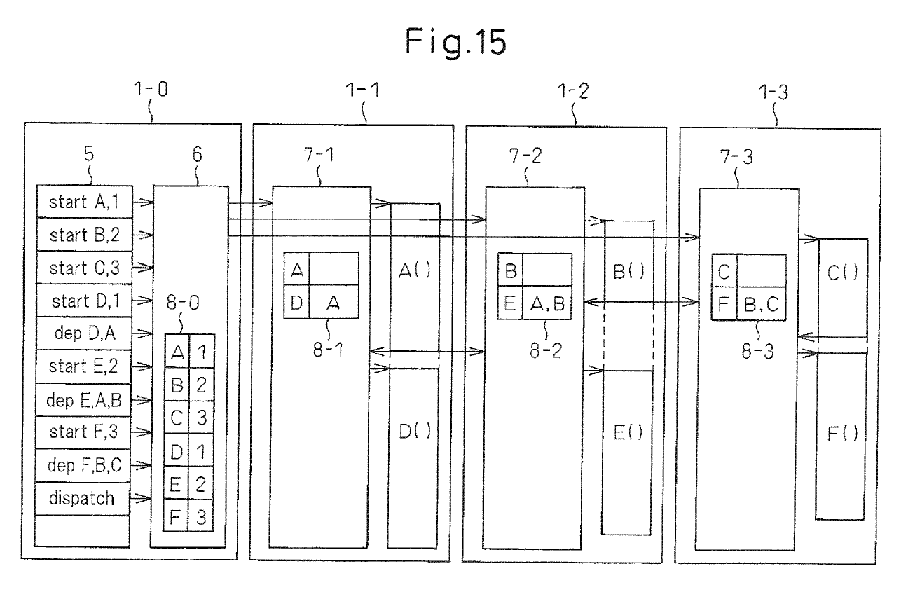

FIG. 15 is a diagram explaining parallel processing in a multiprocessor system in a fourth embodiment. The multiprocessor system in the fourth embodiment differs from that in the first embodiment in that procedure call programs 7-1, 7-2, and 7-3 of the server processors have execution queues 8-1, 8-2, and 8-3, respectively, and others are the same. Procedure request program 6 of client processor 1-0 has execution queue 8-0 in which a procedure to be executed and a server processor that executes the procedure are described, and manages the entire execution state.

In this embodiment, in the sequential execution program, which server processor executes each procedure (program unit) is specified and when a procedure to be executed, a server processor that executes the procedure, and dependencies are described in execution list 5, procedure request program 6 of client processor 1-0 notifies its corresponding server processor of the information. In response to this, each server processor registers the procedure to be executed and the dependencies in each execution queue.

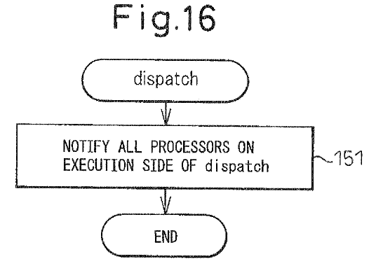

FIG. 16 is a diagram showing processing after dispatch in the fourth embodiment. Upon receipt of “dispatch”, procedure request program 6 of client processor 1-0 notifies all server processors 1-1, 1-7, and 1-3 of “dispatch”.

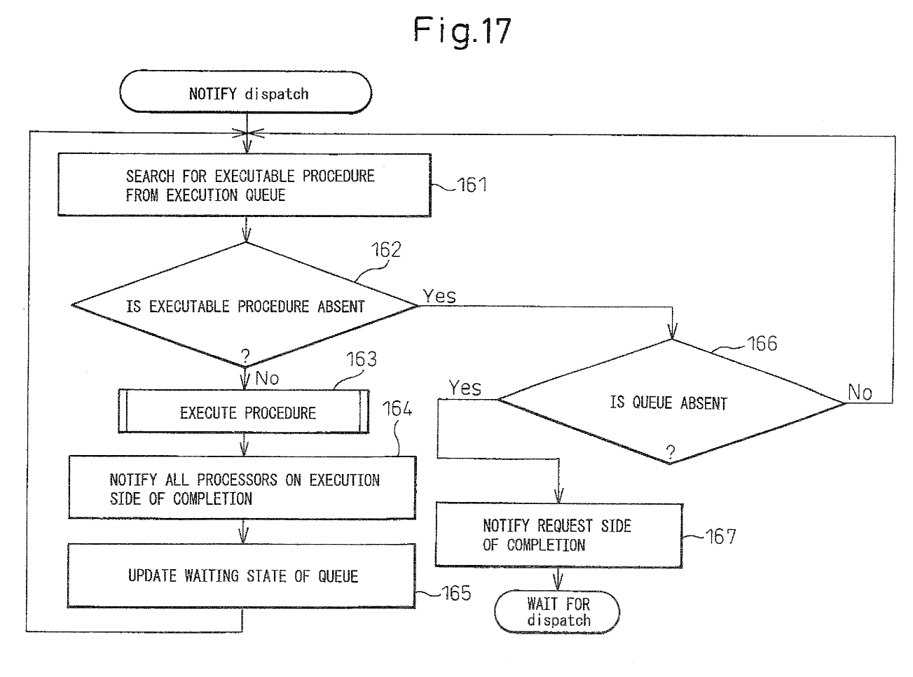

FIG. 17 is a diagram showing the processing of the procedure call program of the server processor after “dispatch” is notified. After receiving the “dispatch” notification, each procedure call program searches for an executable procedure from each execution queue in step 161 and determines whether there is an executable procedure in step 162. If there is an executable procedure, the procedure call program advances the processing to step 163 and executes the procedure. Then, when the execution of the procedure is completed, the procedure request program notifies all server processors 1-1, 1-2, and 1-3 of the completion in step 164, change the execution state of the procedure in the execution queue to the state of completion in step 165, and returns the processing to step 161.

In step 162, if it is determined that there is no executable procedure, the procedure call program 2C) determines whether there remains a procedure to be executed in the execution queue in step 166 and if there remains such a procedure, the procedure call program returns the processing to step 161. If such a procedure does not remain, the procedure call program advances the processing to step 167, notifies procedure request program 6 of client processor 1-0 that the procedure the activation of which has been requested, i.e., the assigned procedure has been completed, and then, enters the state of waiting for the next dispatch.

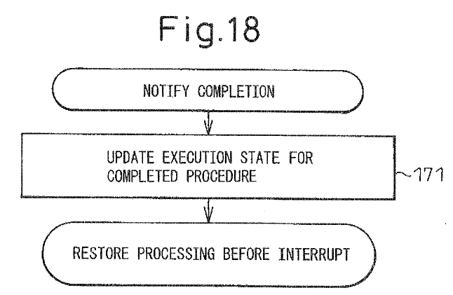

FIG. 18 is a diagram showing processing when procedure request program 6 of client processor 1-0 is notified by the procedure call program of the server processor that the procedure has been completed. When receiving the notification of completion, procedure request program 6 changes the execution state to state of completion for the completed procedure in execution queue 8-0 in step 171.

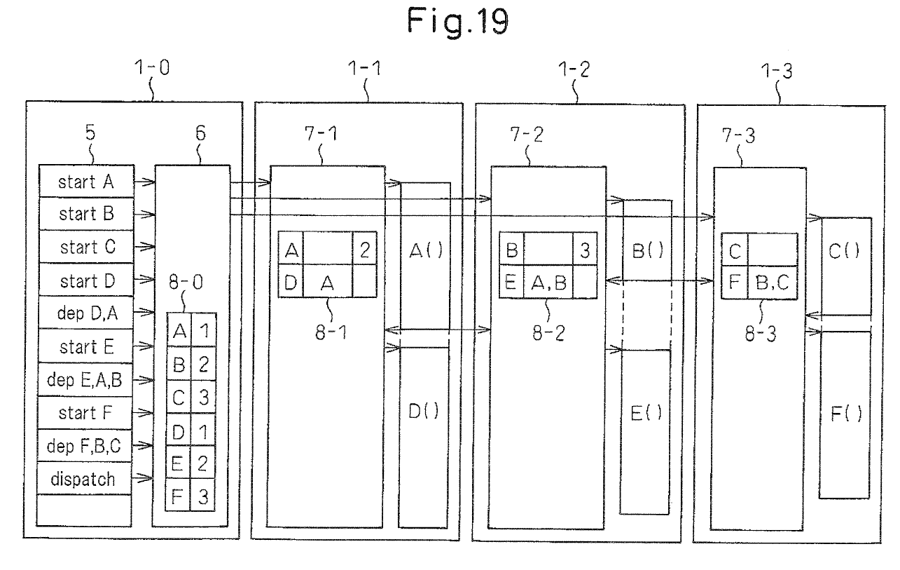

FIG. 19 is a diagram explaining parallel processing in a multiprocessor system in a fifth embodiment. The multiprocessor system in the fifth embodiment differs from that in the fourth embodiment in that the information of another server processor is registered for a procedure that is affected by the results of the procedure to be executed and which is executed by the other server processor in execution queues 8-1, 8-1, and 8-3 of procedure call programs 7-1, 7-2, and 7-3, and others are the same.

The procedure that is affected by the results of the executed procedure and which is executed by another server processor is known, and therefore, it is only necessary to notify the server processor of the completion of execution.

In the multiprocessor system in the first embodiment, the notification of completion of the procedure from the server processor is received by interrupt; however it is also possible to do this by palling. A multiprocessor system in a sixth embodiment differs from the multiprocessor system in the first embodiment in that the notification of completion of the procedure is received by polling, and others are the same.

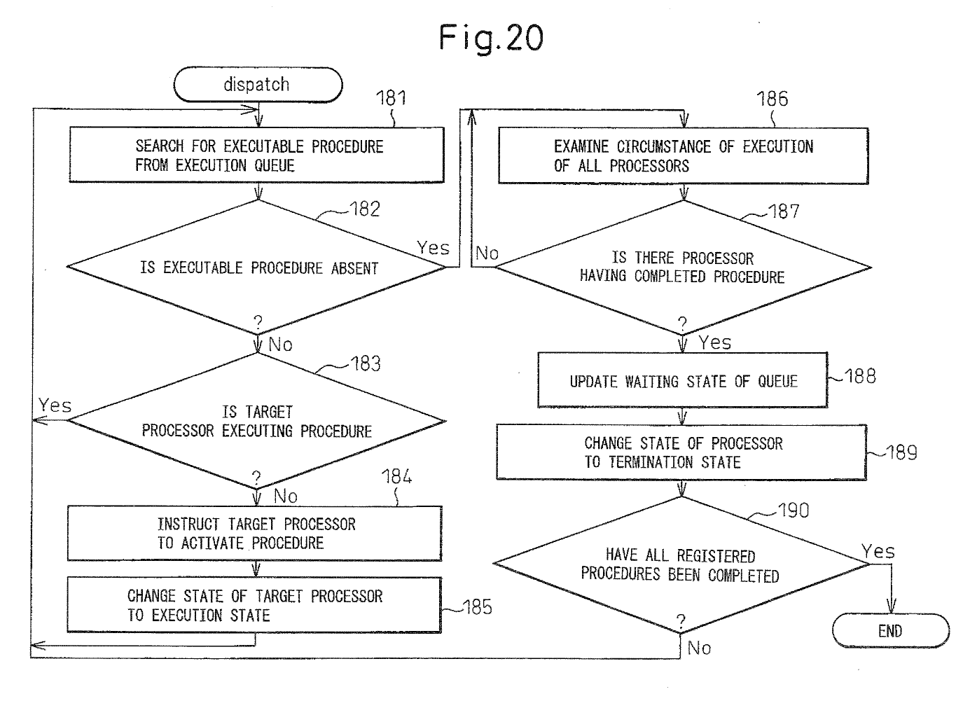

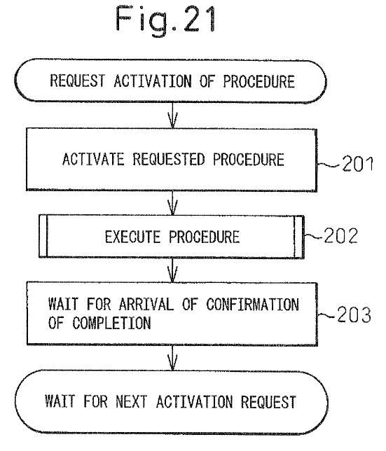

In order to receive the notification of completion of a procedure by polling, in the multiprocessor system in the sixth embodiment, the procedure request program of the client processor carries out processing after dispatch in FIG. 20 and the procedure call program of the server processor carries out procedure call processing in FIG. 21.

In the processing after dispatch in FIG. 20, after “dispatch” is received, the procedure request program searches for an executable procedure from execution queue 8-0 in step 181. In step 182, the procedure request program determines whether there is an executable procedure. If there is an executable procedure, the procedure request program determines whether a target server processor is executing a procedure in step 183. If in execution, the procedure request program returns the processing to step 181, and if not, advances the processing to step 184 and instructs the target server processor to activate the procedure. Then, in step 185, the procedure request program changes the state of the target server processor to the execution state and returns the processing to step 181.

In step 182, when it is determined that there is no executable procedure, the procedure request program examines the circumstances of execution of all server processors 1-1, 1-2, and 1-3 in step 186, and determines whether there is a server processor that has completed a procedure in step 187. If not, the procedure request program returns the processing to step 186 and repeats steps 186 and 187 until any of the server processors completes a procedure. If there is a server processor that has completed a procedure, the procedure request program changes the waiting state of execution queue 8-0 in step 188, changes the state of the server processor to the termination state in step 189, and determines whether all the registered procedures have been completed in step 190. When completed, the procedure request program ends the processing and if not, returns the processing to step 181.

In the procedure call processing in FIG. 21, upon receipt of a procedure activation request from client processor 1-0, the procedure call program of the server processor activates the requested procedure in step 201 and executes the procedure in step 202. Even after having completed the procedure, the procedure call program makes no notification of completion but waits until the arrival of a completion confirmation request from procedure request program 6 of client processor 1-0 in step 203, and when the completion confirmation request arrives, the procedure call program makes the notification of the completion and waits for the next activation request.

The use of the polling processing in the sixth embodiment can also be applied to the second and third embodiments.

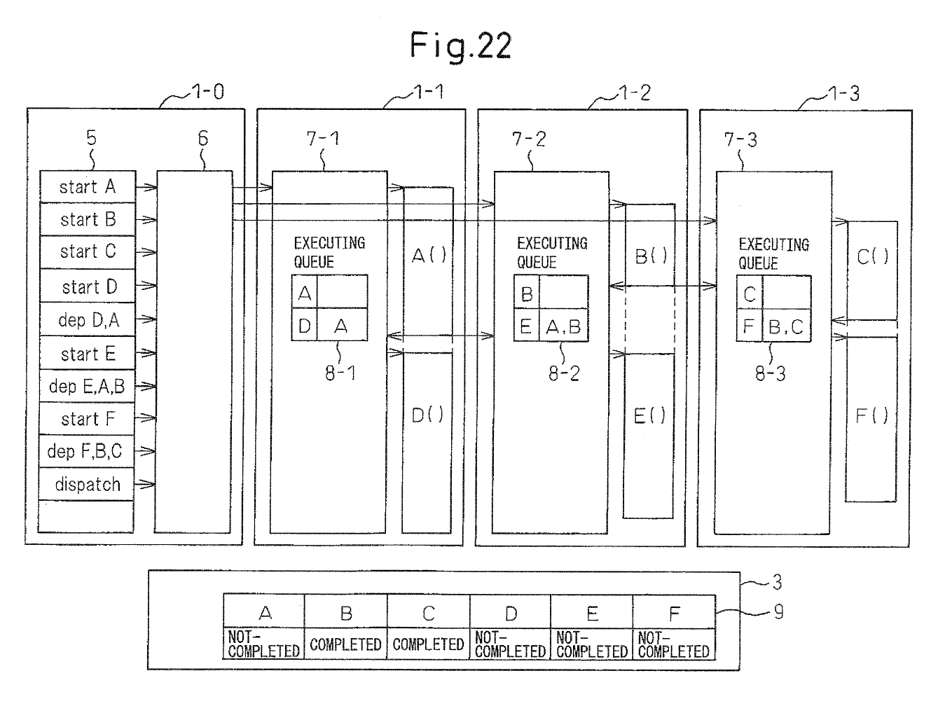

FIG. 22 is a diagram explaining parallel processing in a multiprocessor system in a seventh embodiment. The multiprocessor system in the seventh embodiment differs from that in the fourth embodiment in that the processors have a region in which reading and writing to and from each other are possible in shared memory 3 and an execution state table 9 in which the execution state of a procedure is described is provided in the region, instead of that the notification of completion is made by interrupt to other server processors after the procedure has been completed as in the fourth embodiment. Having completed the assigned procedure, each server processor updates execution state table 9. It is possible for each server processor to know which procedure has been completed by referring to execution state table 9.

Execution state table 9 itself is prepared by procedure request program 6 of client processor 1-0. Procedure request program 6 specifies the position of of a procedure when creating execution queues 8-1, 8-2, and 8-3 by registering procedures in procedure call programs 7-1, 7-2, and 7-3. Because of this, procedure request program 6 carries out the processing after dispatch in FIG. 16.

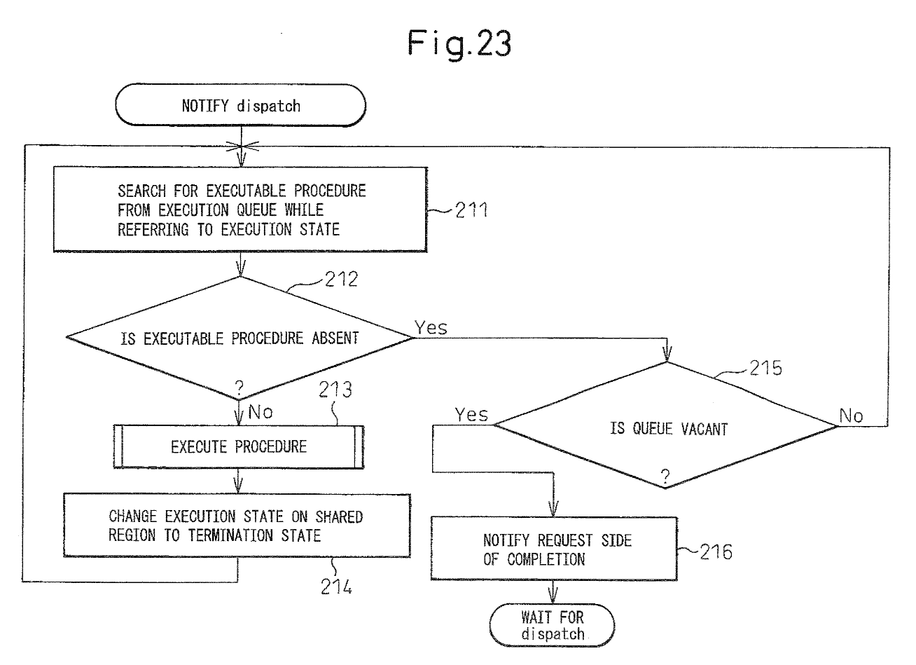

In addition, the procedure call program carries out procedure call processing shown in FIG. 23. The procedure call processing in FIG. 23 is similar to the processing in FIG. 17, that is, the processing in FIG. 17 from which step 164 has been deleted.

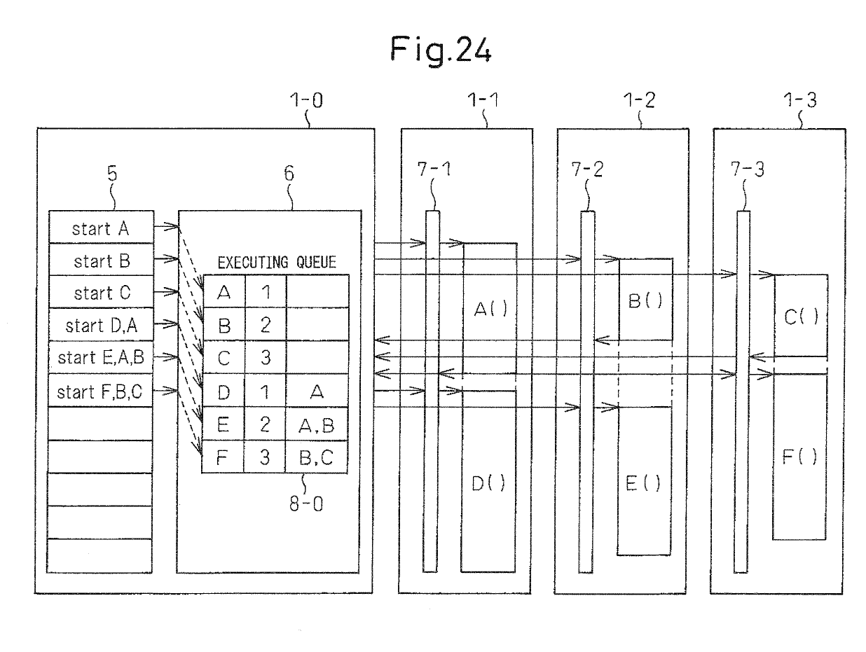

FIG. 24 is a diagram explaining parallel processing in a multiprocessor system in an eighth embodiment. The multiprocessor system in the eighth embodiment differs from that in the first embodiment in that the dependencies are also described in the sequential execution program and the dependencies are also included when execution list 5 is created, and when a procedure to be executed is registered in execution queue 8-0, the dependencies are also registered automatically, and others are the same as those in the first embodiment. Consequently, it is not necessary to wait until the dependencies are registered, “dispatch” is not necessary, and the same processing as “dispatch” is carried out when a procedure and its dependencies are registered in execution queue 8-0. This processing method can also be applied to the second to fifth embodiments.

The embodiments are explained as above; however it is obvious that there can be various modifications.

We claim:

1. A multiprocessing method in a multiprocessor system comprising: a client processor; a plurality of server processors; and a communication path connecting the client processor and the plurality of server processors to establish data communication therebetween, wherein the client processor executes a plurality of program units of a sequential execution program storing the plurality of program units in order by assigning the plurality of program units to the plurality of server processors, and wherein:
registering an order of execution of the plurality of program units in the sequential execution program and dependencies of the plurality of program units; and
managing the execution states of the plurality of program units based on the registered dependencies, determining executable program units, and sequentially assigning the executable program units to the plurality of server processors to be executed.

2. The multiprocessing method according to claim 1, wherein:
the client processor executes a procedure request program carrying out processing to assign the program units to the plurality of server processors; and
the server processor executes a procedure call program carrying out processing to call and execute the program units.

3. The multiprocessing method according to claim 2, wherein:
the procedure request program generates an execution queue registering the execution order of the plurality of program units and the dependencies;
the procedure request program manages the execution states of the plurality of program units based on the execution queue, determines an executable program unit, and calls the server processors sequentially; and
the procedure call program notifies the procedure request program of the completion of execution of an assigned program unit.

4. The multiprocessing method according to claim 3, wherein:
the execution queue has server assignment information about a server processor to which the execution of each program unit is assigned; and
the procedure request program assigns an accordance with the execution queue.

5. The multiprocessing method according to claim 4, wherein:
the execution queue is generated in correspondence to each server processor.

6. The multiprocessing method according to claim 3, wherein:
the procedure request program manages the vacant states of the plurality of server processors and assigns executable program units to the server processors in the vacant state.

7. The multiprocessing method according to claim 2, wherein:
the procedure call program generates an execution queue including the execution order of the program units assigned to the client processor and the information about the dependencies, manages the execution states of the program units based on the execution queue, determines executable program units, and executes the program units sequentially.

8. The multiprocessing method according to claim 7, wherein:
the procedure call program notifies other client processors of the completion of execution of the program unit.

9. The multiprocessing method according to claim 7, wherein:
the procedure call program notifies another client processors carrying out program units having dependencies with the program unit of the completion of execution of the program unit.

10. A multiprocessor system comprising a client processor, a plurality of server processors, and a communication path connecting the client processor and the plurality of server processors to establish data communication, wherein:
the client processor executes a sequential execution program that stores a plurality of procedure program units in order by carrying out a call procedure to call the plurality of server processors asynchronously and assigning the plurality of program units to the plurality of server processors;
the system comprises an execution queue registering the execution order of the plurality of program units and the dependencies of the plurality of program units from the sequential execution program; and
the system manages the execution states of the plurality of program units based on the dependencies registered in the execution queue, determines executable program units, and sequentially assigns the executable program units to the plurality of server processors to be executed.
